(19) United States
(12) Patent Application Publication
(10) Pub. No.: US 2013/0051023 A1
(43) Pub. Date: Feb. 28, 2013

(54) Light Bar and Manufacturing Method Thereof

(71) Applicants: Tzu-Chien Huang, Taoyuan (TW); Yu-Lun Tseng, Taoyuan (TW); Ting-Wei Fang, Taoyuan (TW); Jen-Yan Huang, Taoyuan (TW); Po-Feng Tsai, Taoyuan (TW)

(72) Inventors: Tzu-Chien Huang, Taoyuan (TW); Yu-Lun Tseng, Taoyuan (TW); Ting-Wei Fang, Taoyuan (TW); Jen-Yan Huang, Taoyuan (TW); Po-Feng Tsai, Taoyuan (TW)

(73) Assignee: BRIVIEW CORPORATION, Taoyuan (TW)

(21) Appl. No.: 13/553,929

(22) Filed: Jul. 20, 2012

(30) Foreign Application Priority Data
Aug. 26, 2011 (TW) 100130778

(51) Int. Cl. F21S 4/00; F21V 17/06

(52) U.S. Cl. 362/249.14; 29/825

(57) ABSTRACT

A light bar includes a metal substrate, an electronic component, and a plurality of light source. The metal substrate has a folding line and an opening portion, wherein the folding line extends along a longer side of the metal substrate, and the opening portion connects an end of the folding line from a gap of a first edge of the metal substrate. The metal substrate is bent along the folding line, and a fastening portion and a bearing portion are formed on two sides of the folding line, wherein a circuit is formed on the bearing portion, the electronic component is disposed on the bearing portion and connects the circuit, and a gap is formed between the fastening portion and the electronic component. The light sources are disposed on the metal substrate, and the electronic component and the light sources are electrically coupled with the circuit.

### BACKGROUND OF THE INVENTION

1. Field of the Invention

The present invention relates to a light bar and the manufacturing method thereof; particularly, the present invention relates to a light bar and the manufacturing method of the light bar which elevate heat dissipation efficiency and simplify the process.

2. Description of the Prior Art

With advances in technology, lighting sources for saving electricity and with more brightness are developed continuously in photoelectric-related industries. For example, Light Emitting Diode (LED) is the most common light source and has advantages such as electricity consumption and less heat producing. LED has substituted for the traditional lighting devices and has been widely employed in various aspect of daily life such as flashlight, desk lamp, monitor displayer, billboard advertisement, and building wall. However, the light bar utilizing LED as light source is an electric device still having heat, so it is a major subject to design a better light bar structure and dissipate the heat from the light bar.

Referring to FIG. 1, FIG. 1 is a schematic view of the conventional structure of a backlight display. Generally speaking, a conventional backlight display includes a light bar 100, a heat dissipation plate 200 and a back plate 300. The light bar 100 has a plurality of light sources 400, substrate 500 and connector 600 wherein the light source 400 is a LED. The light sources 400 and connector 600 are disposed on the substrate 500 and the heat dissipation plate 200 is disposed between the substrate 500 and the back plate 300. In reality, each of the light bar 100, spaces respectively exist between the heat dissipation plate 200 and the back plate 300. The spaces influence the heat dissipation effect of the light bar 100 so that the light bar 100 cannot dissipate heat effectively. Besides, the light bar 100 is attached to the heat dissipation plate 200 by screws 700 which have a influence on the optical quality to producing Newton ring or non-uniform luminance leading the light bar 100 performing bad lighting effect.

In practical situations, in order to meet different demands, the backlight display prefers to adopt light bars 100 with L-shaped structure. However, in the traditional bending process, the bending portion of the light bar 100 is apt to squeeze the connector 600 adjacent to each other so that the connector 600 is easily hurt, causing the yield rate to decrease.

### SUMMARY OF THE INVENTION

In view of the problems mentioned above, it is an object of the present invention to provide a manufacturing method of a light bar with high producing efficiency and good heat dispassion.

It is another object of the present invention to provide the light bar utilizing a metal substrate to improve the heat dissipation effect.

It is another object of the present invention to provide the light bar utilizing an opening portion to bend the light bar and to elevate the yield rate of the light bar.

It is another object of the present invention to provide a simplified manufacturing method of the light bar to improve the producing efficiency.

The present invention provides a light bar including a metal substrate, an electronic component, and a plurality of light sources. The metal substrate has a folding line and an opening portion, wherein the folding line extends along a longer side of the metal substrate and the opening portion connects one end of the folding line along a direction parallel to the folding line from a breach of a first edge of the metal substrate.

The metal substrate is bent along the folding line to form a fastening portion and a bearing portion on two sides of the folding line respectively, wherein an electronic circuit is formed on the bearing portion. The electronic component is disposed on the bearing portion and electrically connecting the electronic circuit, wherein a gap is formed between the fastening portion and the electronic component in a direction parallel to the bearing portion. The plurality of light sources is disposed on the bearing portion along the longer side of the metal substrate and the electronic circuit electrical couples to the electrical component and the light sources.

It is noted that the folding line is recessed in the metal substrate. Besides, the distance between the electronic component and the folding line is at least 0.5 mm and the distance between the light sources and the folding line is not smaller than 0.5 mm.

In comparison to the conventional technology, the light bar and the light bar manufacturing method are utilizing a metal as a substrate to allow the heat from the light sources can dissipating directly through the metal substrate to achieve the purpose of effectively dissipating heat. In addition, the folding line is recessed in the metal substrate to make the metal substrate bent along the folding line to reducing the defective rate of the light bar. Further, by regulating the distance between the opening portion and the electronic component, the fastening portion is prevented from pressing the electronic component while bending the light bar and the producing yield rate can be promoted.

The advantages and the features of the present invention will be described in the following description and will be learned in the drawings therewith.

### BRIEF DESCRIPTION OF THE DRAWINGS

FIG. 1 shows a schematic view of the conventional structure of a backlight display;

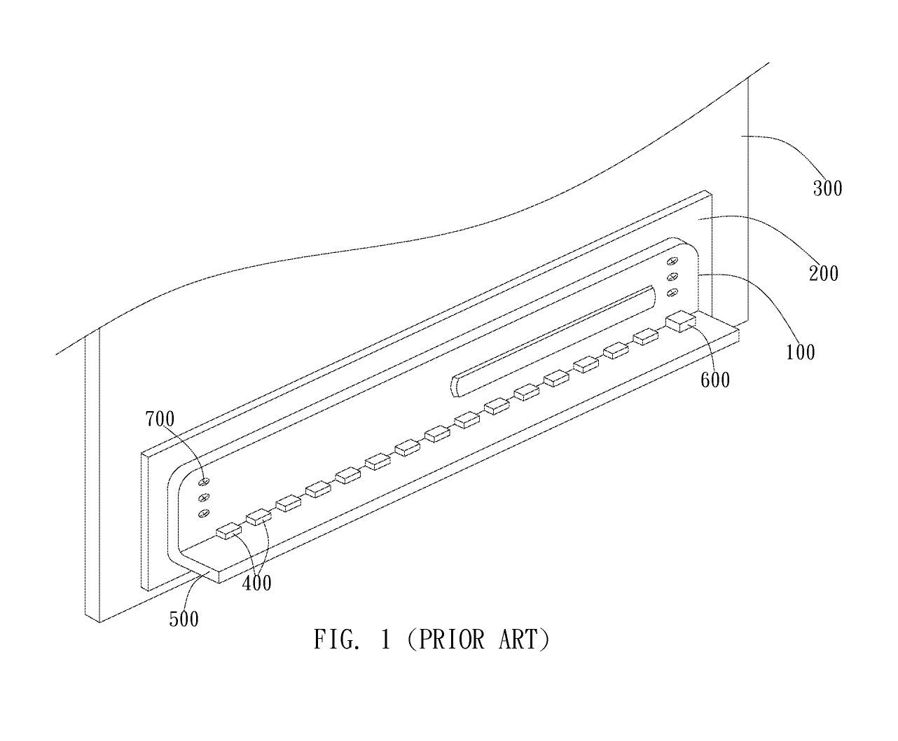

FIG. 2 shows a schematic view of one embodiment of the light bar;

FIG. 3 shows an exploded view of the backlight module and the light bar;

FIG. 4 shows a schematic view of one embodiment of the light bar;

FIG. 5 shows a top view of the light bar before being bent;

FIG. 6 shows a flowchart of the process making the light bar;

FIG. 7 shows a flowchart of the process making the opening portion;

FIG. 8 shows a schematic view utilizing the first bending method;

FIG. 9 shows the flowchart of the first bending method;

FIG. 10 shows a schematic view utilizing the second bending method;

FIG. 11 shows the flowchart of the second bending method.

### DETAILED DESCRIPTION OF THE PREFERRED EMBODIMENT

According to one embodiment of the present invention, the light bar is provided for raising the heat dissipating efficiency. In this embodiment, the light bar includes a light emitting diode light bar.

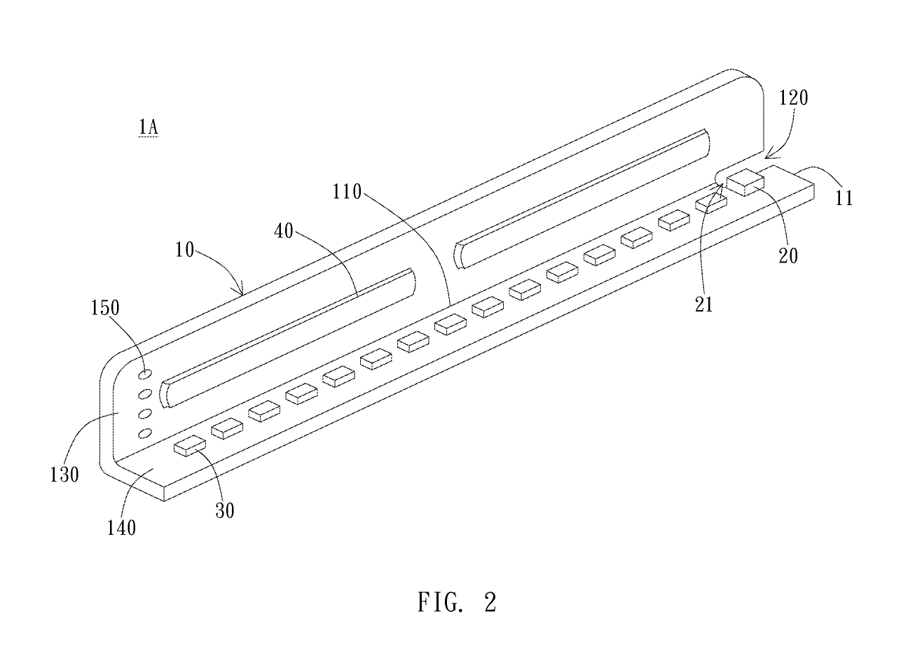

Please refer to FIG. 2; FIG. 2 shows a schematic view of one embodiment of the light bar. As shown in FIG. 2, the light bar 1A includes a metal substrate 10, an electronic component 20, and a plurality of light sources 30. In this embodiment, the electronic component 20 includes a connector, and the light sources include light emitting diodes. The electronic component 20 connects the light sources 30. In another embodiment, the electronic component 20 may include resistor, capacitor, inductance, electromagnetic shielding component (EMC shielding component) or other components and is not limited to the connector of this embodiment. It is noted that the metal substrate 10 has a folding line 110 and an opening portion 120, wherein the folding line 110 extends along a longer side of the metal substrate 10, and the opening portion 120 connects one end of the folding line 110 along a direction parallel to the folding line 110 from a breach of a first edge 11 of the metal substrate 10. In other words, the opening portion 120, disposed along the folding line 110, is a recessed part of the metal substrate 10 at the first edge 11, and the bottom of the recessed part connects the folding line 110.

The metal substrate 10 is bent along the folding line 110 to form a fastening portion 130 and a bearing portion 140 on two sides of the folding line 110 respectively, wherein an electronic circuit (not shown) is formed on the bearing portion 140. The electronic component 20 is disposed on the bearing portion 140 and electrically connects the electronic circuit, wherein a gap 21 is formed between the fastening portion 130 and the electronic component 20 in a direction parallel to the bearing portion 140. The plurality of light sources 30 is disposed on the bearing portion 140 along the longer side of the metal substrate 10 and the electronic circuit electrical couples to the electrical component 20 and the light sources 30.

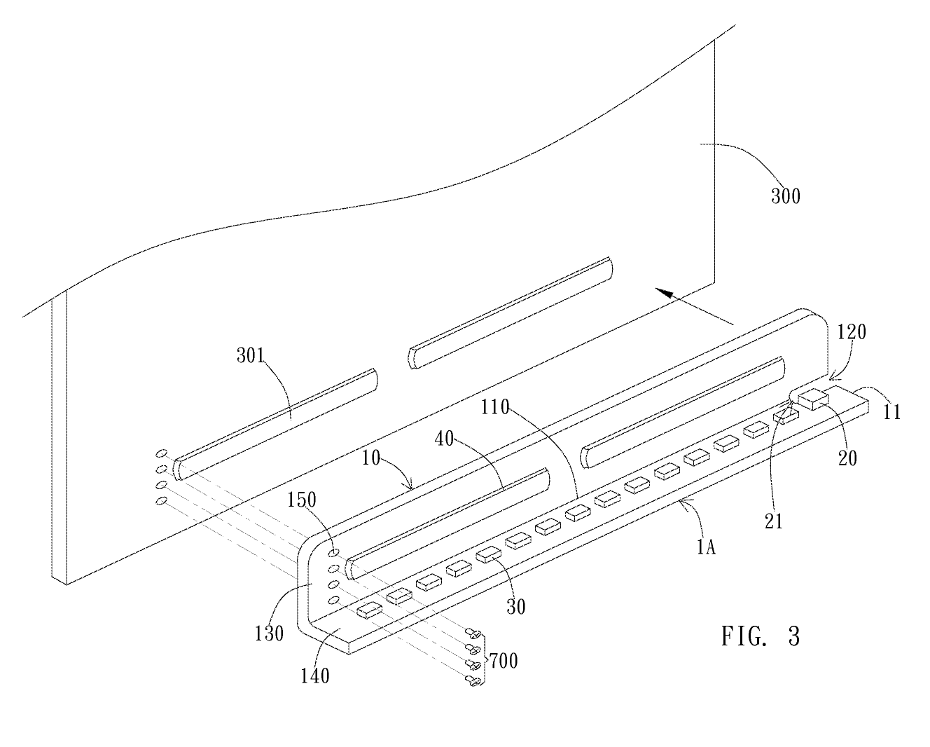

As shown in FIG. 2, the light bar 1A further includes a bump unit 40 and a plurality of through holes 150 for fixing the light bar 1A to the backlight module. Please refer to FIG. 3; FIG. 3 shows an exploded view of the backlight module and the light bar. As shown in FIG. 3, the light bar 1A is fixed on the back plate 300 of the backlight module as the backlight source of the backlight module. The bump unit 40 is disposed on the fastening portion 130 and is corresponding to a positioning structure 301 of the back plate 300 to fix the light bar 1A on the back plate 300. In practical applications, the light bar 1A is positioned on the back plate 300 by the bump unit 40 corresponding to the positioning portion 301 and fixed by the screws 700 passing through the through holes 150.

In particular, the light sources 30 and the electronic components 20 are disposed the metal substrate 10 so as to transmit heat to the metal substrate 10 for heat dissipation. In other words, the metal substrate 10 of the light bar 1A is made of a heat dissipation material and functions as a heat sink, so the material cost can be saved and no more metal dissipation plate is required. Besides, the thickness can be minimized because there is no need to dispose an additional dissipation plate.

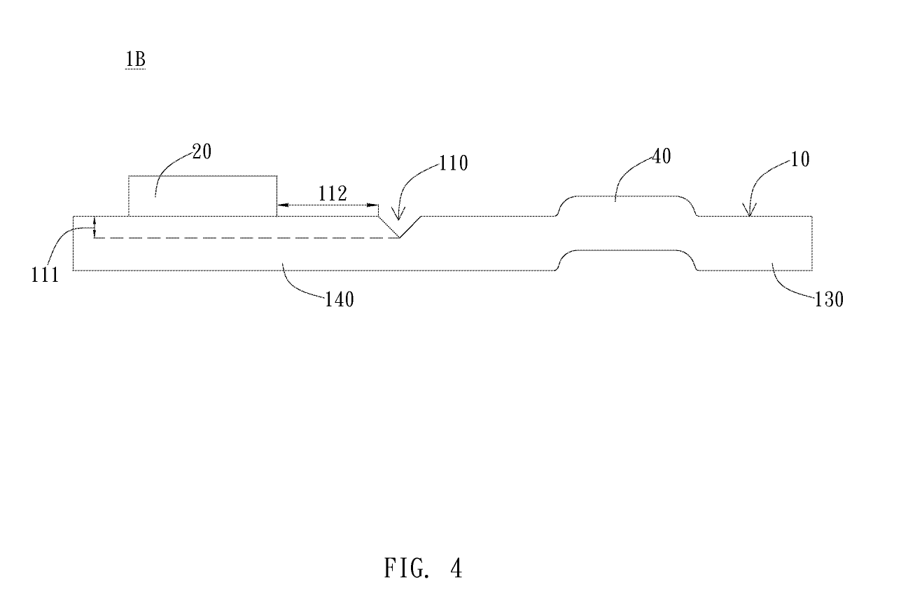

Please refer to FIG. 4; FIG. 4 shows a schematic view of one embodiment of the light bar 1B. As shown in FIG. 4, the folding line 110 is recessed in the metal substrate 10, and the depth 111 of the folding line 110 is preferably not greater than 0.05 times of the thickness of the metal substrate 10. In addition, the first distance 112 between the electronic component 20 and the folding line 110 is preferred at least 0.5 mm. It is noted that the light bar 1B has a recessed folding line 110 which not only preserves a bending position on the metal substrate 10 before the process of bending the light bar 1B but also decreases the defective rate and elevates the yield rate.

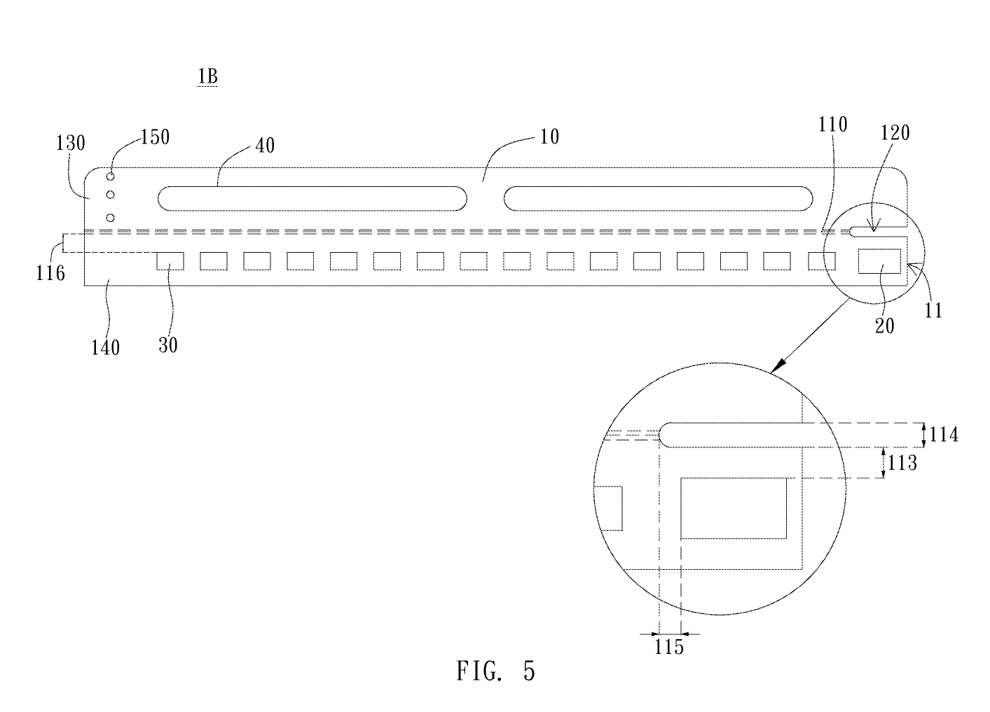

Please refer to FIG. 5; FIG. 5 shows a top view of the light bar before being bent. As shown I FIG. 5, the distance between the electronic component 20 and the opening portion 120 near one side of the electronic component 20, named as second distance 113, is preferably not smaller than 0.5 mm. Besides, the width 114 of the opening portion 120 at the breach of the first edge 111 is preferred not smaller than 0.3 mm. In practical applications, the opening portion 120 is formed at one end of the folding line 110 and the distance between the opening portion 120 and the electronic component 20 is not smaller than 0.5 mm to keep a safe distance between the fastening portion 130 and the electronic component 20 while bending the light bar 1B and avoid the electronic component 20 from being squeezed and damaged.

As shown in FIG. 5, the distance between one end of the folding line 110 and one side of the electronic component 20 away from the first edge 11 in the direction parallel to a shorter side of the metal substrate 10, named as third distance 115, is preferably not smaller than 0.1 mm. The length of the opening portion 120 parallel to the metal substrate 10 should not be too long to prevent breaking occurred while bending the light bar 1B. Besides, the distance between the light sources 30 and the folding line 110 is named a fourth distance 116, which is preferred not smaller than 0.5 mm. In practical applications, the opening portion 120 is formed at one end of the folding line 110 and the distance between the folding line 110 and light sources 30 is not smaller than 0.5 mm to keep a safe distance between the fastening portion 130 and light sources 30 while bending the light bar 1B and avoid light sources 30 from being squeezed by the fastening portion 130 and causing destruction.

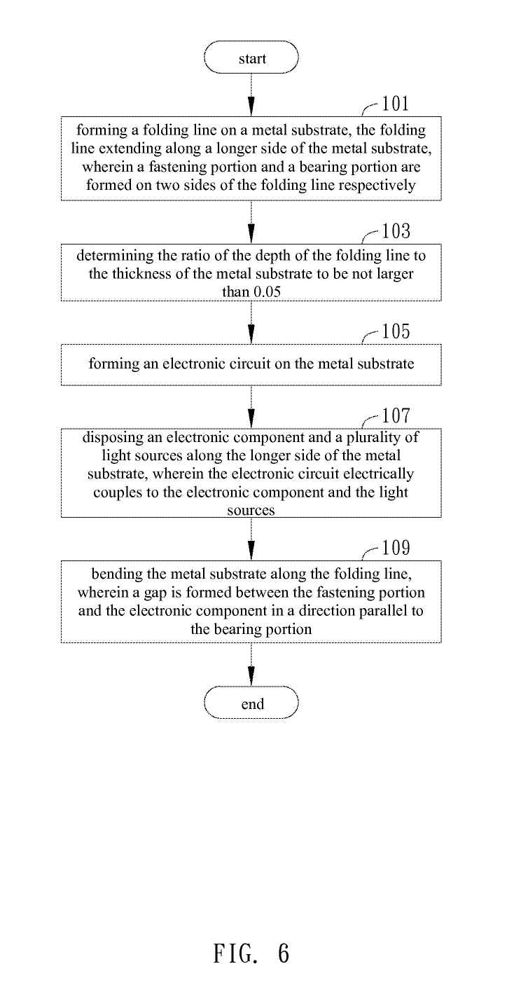

Please refer to FIG. 6; FIG. 6 shows a flowchart of the process making the light bar. The process making the light bar includes following steps. Step 101: forming a folding line on a metal substrate which extends along a longer side of the metal substrate, wherein a fastening portion and a bearing portion are formed on two sides of the folding line respectively; Step 103: determining the ratio of the depth of the folding line to the thickness of the metal substrate to be no greater than 0.05; Step 105: forming an electronic circuit on the metal substrate; Step 107: disposing an electronic component and a plurality of light sources along the longer side of the metal substrate, wherein the electronic circuit electrically couples to the electronic component and the light sources; Step 109: bending the metal substrate along the folding line, wherein a gap is formed between the fastening portion and the electronic component in a direction parallel to the bearing portion. It is noted that when the electronic component is disposed on the metal substrate, the distance between the electronic component and the folding line is at least 0.5 mm.

In practical applications, the folding line is, but not limited to, formed by punch press or stamping press. Besides, an electronic circuit may be formed on the light bar by means of yellow light process such as exposure, etching, and lithography processes without particular restriction. In practical applications, a robot arm, but not limited to, is utilized to clamp the electronic component and light sources for further configuration.

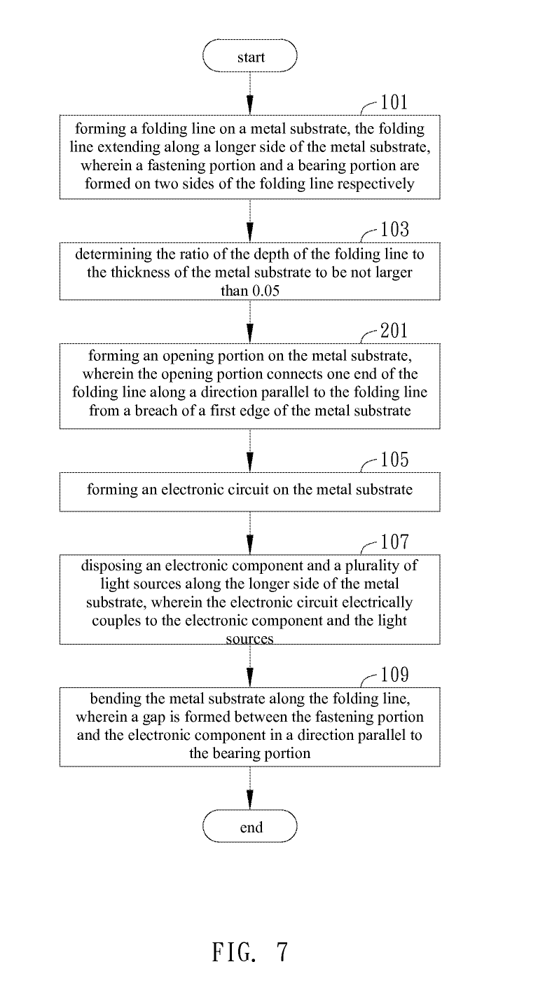

Please refer to FIG. 7; FIG. 7 shows a flowchart of the process making the opening portion. The process making the light bar further includes Step 201: forming an opening portion on the metal substrate, wherein the opening portion connects one end of the folding line along a direction parallel to the folding line from a breach of a first edge of the metal substrate. It is noted that, while forming the opening potion, the distance between the electronic component and the opening portion near one side of the electronic component is not smaller than 0.5 mm and the width of the opening portion at the breach of the first edge is not smaller than 0.3 mm.

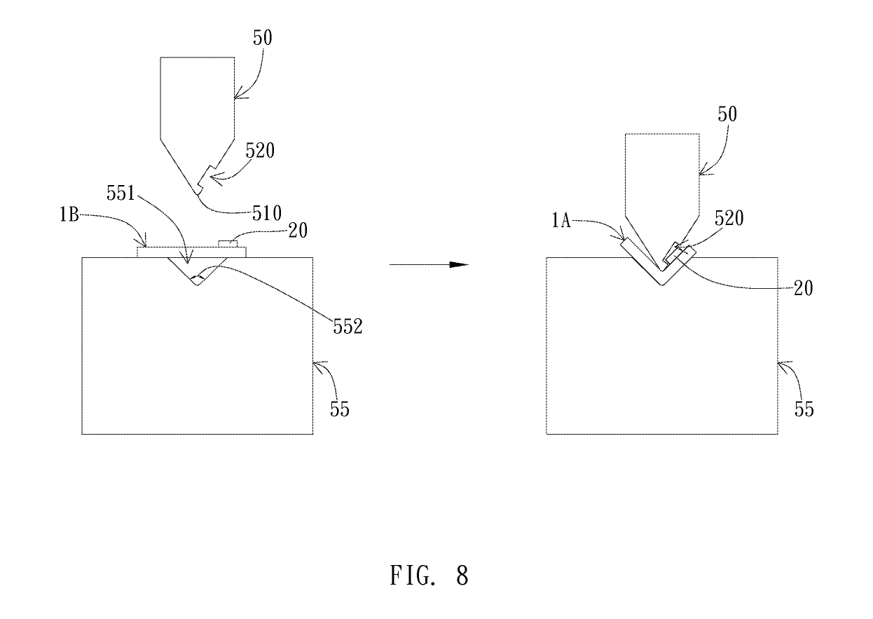

Please refer to FIG. 8; FIG. 8 shows a schematic view utilizing the first bending method. As shown in FIG. 8, a first mold set includes a cutter 50 and a first mold 55. The cutter 50 includes a top edge 510 and at least one first accommodation space 520, wherein the volume of each of the first accommodation space 520 is not smaller than the light sources 30. The first mold 55 includes a recessed portion 551 which recesses in the first mold 55 with a predetermined angle 552.

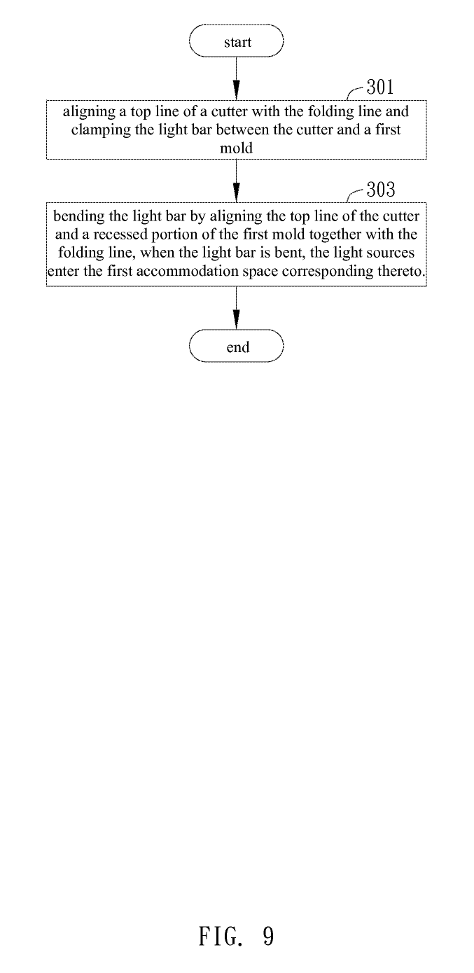

Please refer to FIG. 8 and FIG. 9; FIG. 9 shows the flowchart of the first bending method. The first bending method includes Step 301: aligning the top edge of the cutter to the folding line and clamping the light bar by the cutter and a first mold, and Step 303: bending the light bar by the top edge of the cutter and a recessed portion of the first mold together, which are aligned with the folding line; when the light bar is bent, the light sources respectively enter the corresponded first accommodation spaces.

It is noted that it requires several steps in traditional process of bending light bar; however, the first bending method shown in FIG. 9 can achieve the purpose of bending the light bar in a single step. Besides, the cutter has at least a first accommodation space; the light sources enter the first accommodation space for avoiding being squeezed by the first mold when the light bar is bent. Therefore, the first bending method may simplify the process and promote the yield rate.

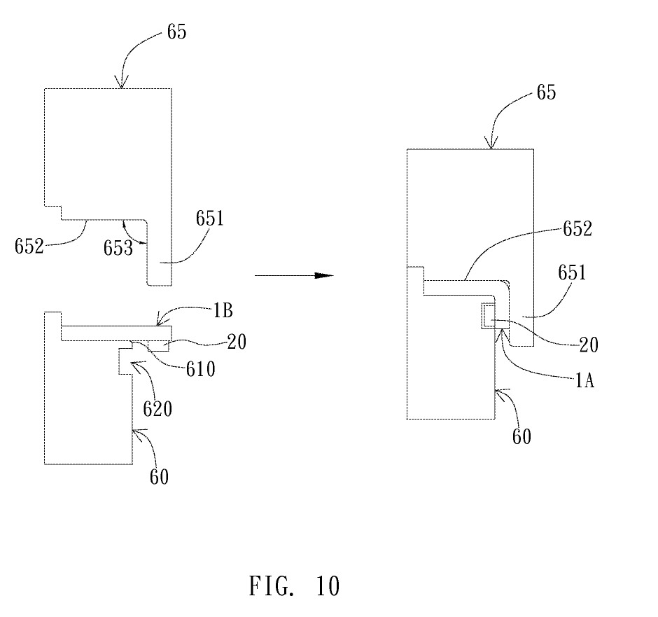

Please refer to FIG. 10; FIG. 10 shows a schematic view utilizing the second bending method. As show in FIG. 10, a second mold set includes an upper mold 65 and a lower mold 60. The upper mold 65 includes a plate 651 and a first surface 652, wherein the plate 651 is perpendicular to the first surface 652. A recessed angle 653 is formed between the plate 651 and the first surface 652. The lower mold 60 includes a flange edge 610 and at least one second accommodation space 620, wherein the flange edge 610 is a boundary line of two surfaces perpendicular to each other and has the predetermined angle. The volume of each of the second accommodation space 620 is not smaller than the light sources 30.

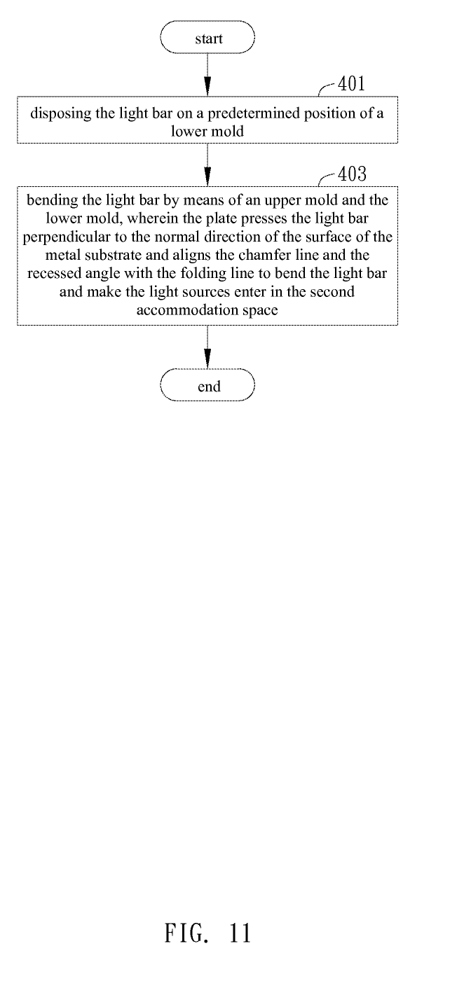

Please refer to FIG. 10 and FIG. 11; FIG. 11 shows the flowchart of the second bending method. The second bending method includes Step 401: disposing the light bar on a predetermined position of lower mold, and Step 403: bending the light bar by means of the upper mold and the lower mold, wherein the plate presses the light bar perpendicular to the normal direction of the surface of the metal substrate, while the flange edge and the recessed angle are aligned with the folding line, to bend the light bar and make the light sources enter in the second accommodation space.

It is noted that, as shown in FIG. 11, the second bending method of pressing the light bar by the upper mold 65 and the lower mold 60 can also achieve the purpose of one-time bending the light bar. Besides, the lower mold 60 includes at least a second accommodation space 620; the light sources enter the second accommodation spaces 620 to avoid being squeezed by the upper mold when the light bar is bent. Therefore, the second bending method may also simplify the process and elevate the yield rate.

In addition, the first mold set and the second mold set shown in FIG. 9 or FIG. 11 are only for illustration purpose. In practical applications, different mold set may also be utilized in the bending methods shown in FIG. 9 and FIG. 11. In other words, there is no specific limitation to the mold structure described in the light bar bending methods, and the shape of molds are not limited to the drawings as shown in FIG. 8 and FIG. 10.

Comparing to the conventional technology, the light bar of the present invention utilizes metal as substrate to transmit heat from the light sources to the metal substrate 10 for heat dissipation to achieve the heat dissipation purpose. In addition, the folding line is recessed in the metal substrate such that the metal substrate bends along the folding line to decrease the defective rate. Furthermore, by regulating the distance between the opening portion and the electronic component, contacts between the fastening portion and the electronic component can be avoided while the light bar is bent, and the yield rate can therefore be promoted. It is noted that the metal substrate of the light bar is made of a heat dissipation material, so the material cost can be saved and no more metal dissipation plate is required. Besides, the thickness can be minimized because there is no need to dispose an additional dissipation plate. On the other hand, by the first bending method and the second bending method mentioned above, the light bar one-time bending process not only simplifies the process but also prevents the light sources from being squeezed through disposing the first accommodation space and the second accommodation space to promote the yield rate.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A light bar, comprising:
a metal substrate having a folding line and an opening portion, wherein the folding line extends along a longer side of the metal substrate, the opening portion connects one end of the folding line along a direction parallel to the folding line from a breach of a first edge of the metal substrate, and the metal substrate is bent along the folding line to form a fastening portion and a bearing portion on two sides of the folding line respectively, wherein an electronic circuit is formed on the bearing portion;
an electronic component disposed on the bearing portion and electrically connecting the electronic circuit, wherein a gap is formed between the fastening portion and the electronic component in a direction parallel to the bearing portion; and
a plurality of light sources disposed on the bearing portion along the longer side of the metal substrate, the electronic circuit electrical coupling to the electrical component and the light sources.

2. The light bar of claim 1, wherein the folding line is recessed in the metal substrate.

3. The light bar of claim 1, wherein the depth of the folding line is not larger than 0.05 times of the thickness of the metal substrate.

4. The light bar of claim 3, wherein the distance between the electronic component and the folding line is at least 0.5 mm.

5. The light bar of claim 1, wherein the distance of the electronic component and the opening portion near one side of the electronic component is not smaller than 0.5 mm.

6. The light bar of claim 1, wherein the width of the opening portion at the breach of the first edge is not smaller than 0.3 mm.

7. The light bar of claim 1, wherein the distance between one end of the folding line and the electronic component in a direction away from one side of the first edge parallel to a shorter side of the metal substrate is not smaller than 0.1 mm.

8. The light bar of claim 1, wherein the distance between the light sources and the folding line is not smaller than 0.5 mm.

9. A light bar manufacturing method, comprising:
(a) forming a folding line on a metal substrate, the folding line extending along a longer side of the metal substrate, wherein a fastening portion and a bearing portion are formed on two sides of the folding line respectively;
(b) forming an electronic circuit on the metal substrate;
(c) disposing an electronic component and a plurality of light sources along the longer side of the metal substrate, wherein the electronic circuit electrically couples to the electronic component and the light sources, and the distance between the electronic component and the folding line is at least 0.5 mm; and
(d) bending the metal substrate along the folding line, wherein a gap is formed between the fastening portion and the electronic component in a direction parallel to the bearing portion.

10. The light bar manufacturing method of claim 9, wherein the step of forming the folding line further comprises: determining the ratio of the depth of the folding line to the thickness of the metal substrate to be not larger than 0.05.

11. The light bar manufacturing method of claim 10, wherein the step (a) further comprises:
forming an opening portion on the metal substrate, wherein the opening portion connects one end of the folding line along a direction parallel to the folding line from a breach of a first edge of the metal substrate.

12. The light bar manufacturing method of claim 9, wherein the step (c) further comprises:
aligning a top edge of a cutter with the folding line and clamping the light bar between the cutter and a first mold; and
bending the light bar by aligning the top edge of the cutter and a recessed portion of the first mold together with the folding line.

13. The light bar manufacturing method of claim 9, wherein the step (c) further comprises:
disposing the light bar on a predetermined position of a lower mold; and
bending the light bar by means of an upper mold and the lower mold.
